(19) United States
(12) Patent Application Publication
(10) Pub. No.: US 2007/0216352 A1
(43) Pub. Date: Sep. 20, 2007

(54) Cell phone charging stand

(76) Inventor: Thomas Shaddle, San Leandro, CA (US)

Correspondence Address: Thomas Shaddle, 2800 Darius Way, San Leandro, CA, 94577, US

(21) Appl. No.: 11/367,795

(22) Filed: Mar. 6, 2006

(51) Int. Cl. H02J 7/00

(52) U.S. Cl. 320/114

(57) ABSTRACT

Cell phone charging stand with a plurality of modular hollow housings, each including an upwardly facing cell phone receiving receptacle, the modular housings capable of attaching to each other to form a line of housings. A name plate retaining pocket is located on the front surface of each modular housing. Each modular housing encloses a spring biased electrical cord. The electrical cord connects on one end to a socket located on the side wall of the housing and on the opposite end to a universal electrical jack. The universal jack is capable of receiving an adaptor plug that can customize the cell phone receiving housing to a user's cell phone. An AC to DC wall pack transformer and standard cell phone charging circuit supplies power to each cell phone charging electrical cord.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of cell phone accessories and more specifically to a cell phone charging stand.

Cellular telephones, or cell phones as they are commonly called, are wireless phone calling devices that have become very popular around the world. Cell phones are powered by an internal battery that must be recharged regularly. Recently, cell phone marketing companies have been offering “family plans” that allow each member of a family to own a cell phone at an affordable rate thereby creating multiple cell phone families.

Currently, to charge a cell phone, the user plugs an AC to DC wall pack adaptor into a 120 volt AC outlet and then plugs his or her cell phone into the jack located at the end of the AC to DC adaptor cord. The owner of each phone has his or her own wall pack adaptor and associated electrical cords.

Unfortunately, the proliferation of cell phones and the trend toward multiple cell phone families has caused massive cord clutter and confusion over whose phone is whose.

### BRIEF SUMMARY OF THE INVENTION

The primary object of the invention is to provide a cell phone charging stand that is capable of charging a plurality of cell phones at one time.

Another object of the invention is to provide a cell phone charging stand that is modular so that charging stations can be added or subtracted.

Another object of the invention is to provide a cell phone charging stand that will adapt to accommodate all commonly available cell phones.

A further object of the invention is to provide a cell phone charging stand that can rest on a counter top or be hung on a wall.

Yet another object of the invention is to provide a cell phone charging stand where each module includes a frame capable of receiving a name card of the individual cell phone owner.

Still yet another object of the invention is to provide a cell phone charging stand that allows the charging cord to extend from and automatically retract into the housing as needed thereby eliminating unsightly cord clutter.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a cell phone charging stand comprising: a plurality of modular hollow housings, each including an upwardly facing cell phone receiving receptacle, said modular housings capable of attaching to each other to form a line of housings, a pair of opposing end panels that enclose the far left and far right side of said line of said modular housings, a name plate retaining pocket located on the front surface of each said modular housing, said modular housing enclosing a spring biased electrical cord, said electrical cord connecting on one end to a socket located on the side wall of said housing and on the opposite end to a universal electrical jack, said universal jack capable of receiving an adaptor plug that can customize said cell phone receiving housing to a user's cell phone, said side wall socket capable of receiving a mating plug from an adjacent cell phone housing, and an AC to DC wall pack transformer and standard cell phone charging circuit that supplies electrical power to each said cell phone charging electrical cord.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a side section view of one modular housing with a cell phone in place.

FIG. 3 is a side section view of one modular housing with a cell phone and attached cord pulled out of its receptacle.

FIG. 4 is a perspective view showing the electrical attachment means to connect one module to another.

FIG. 5 is a front view of the invention.

FIG. 6 is a side view of the invention attached to a wall.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

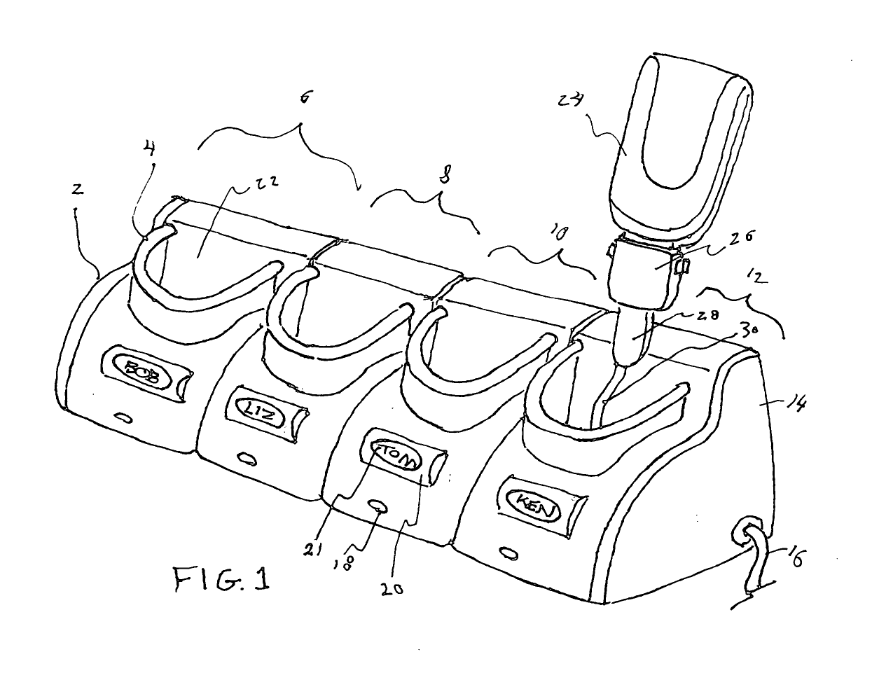

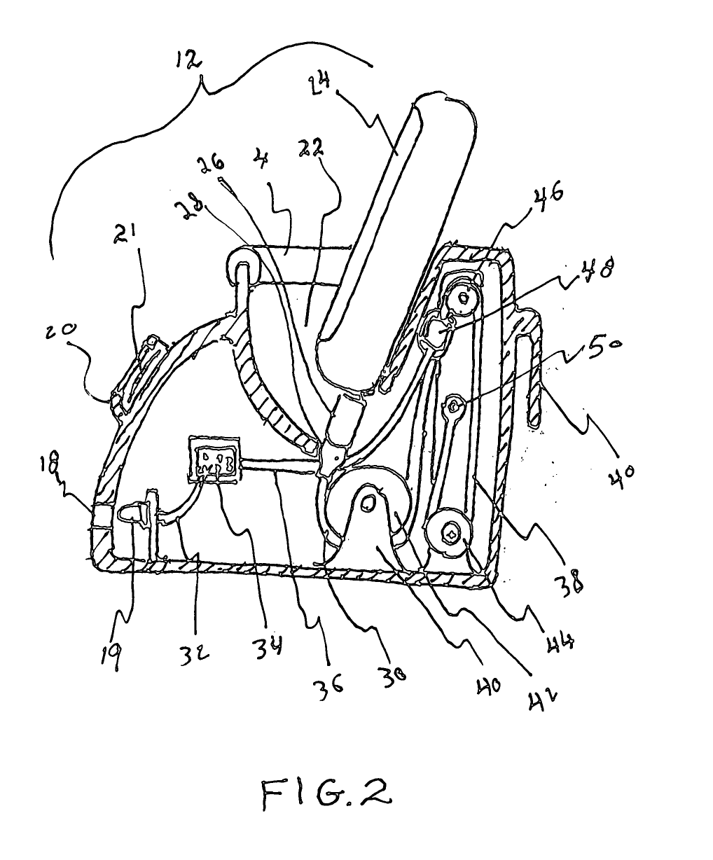

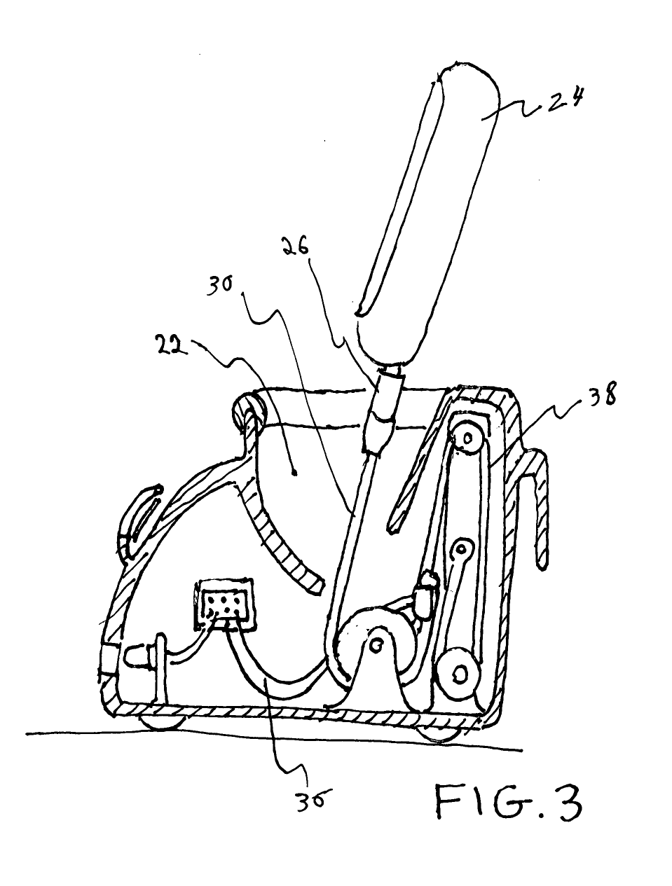

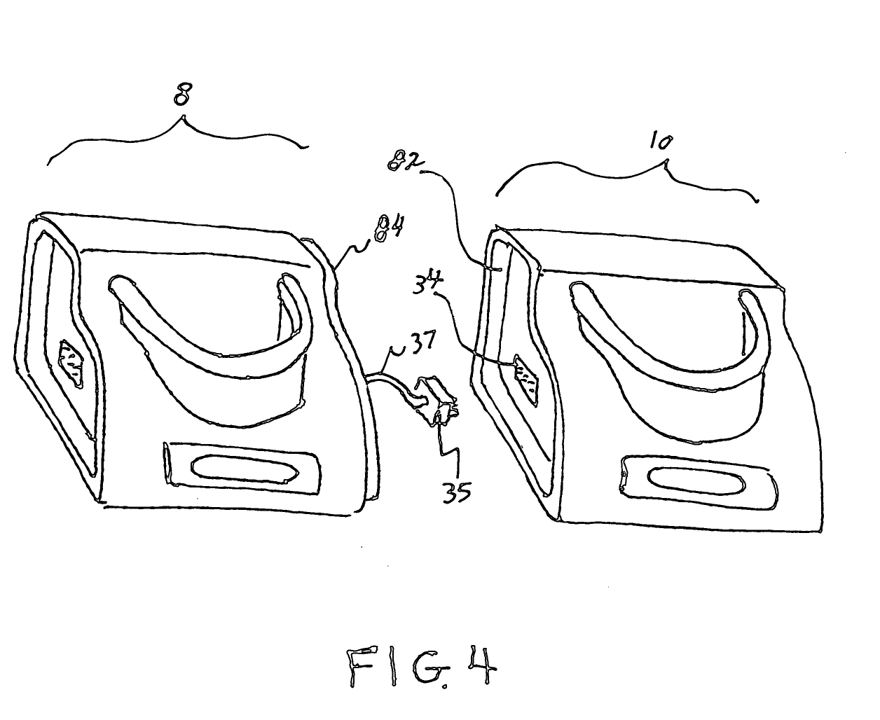

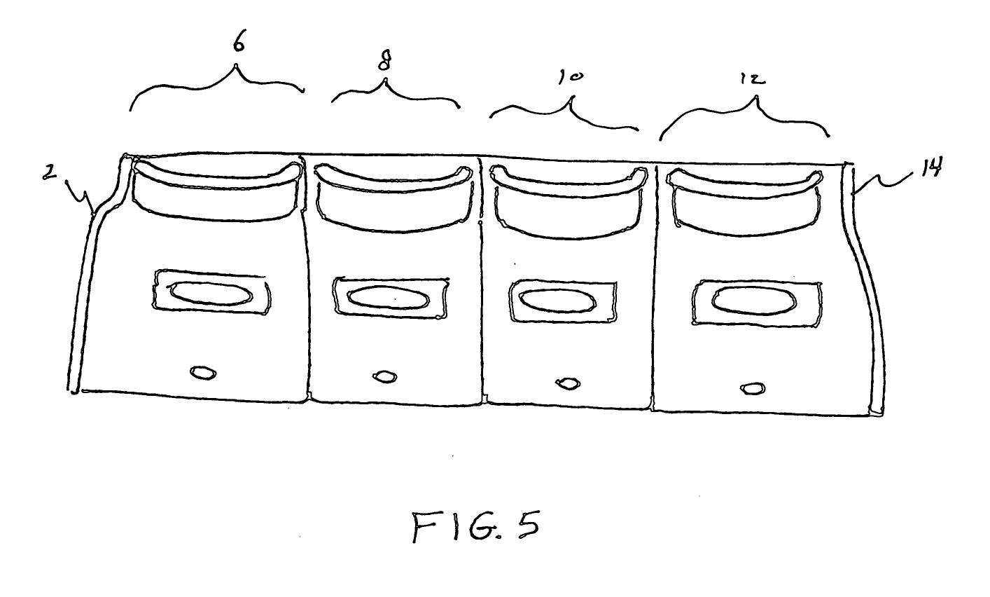

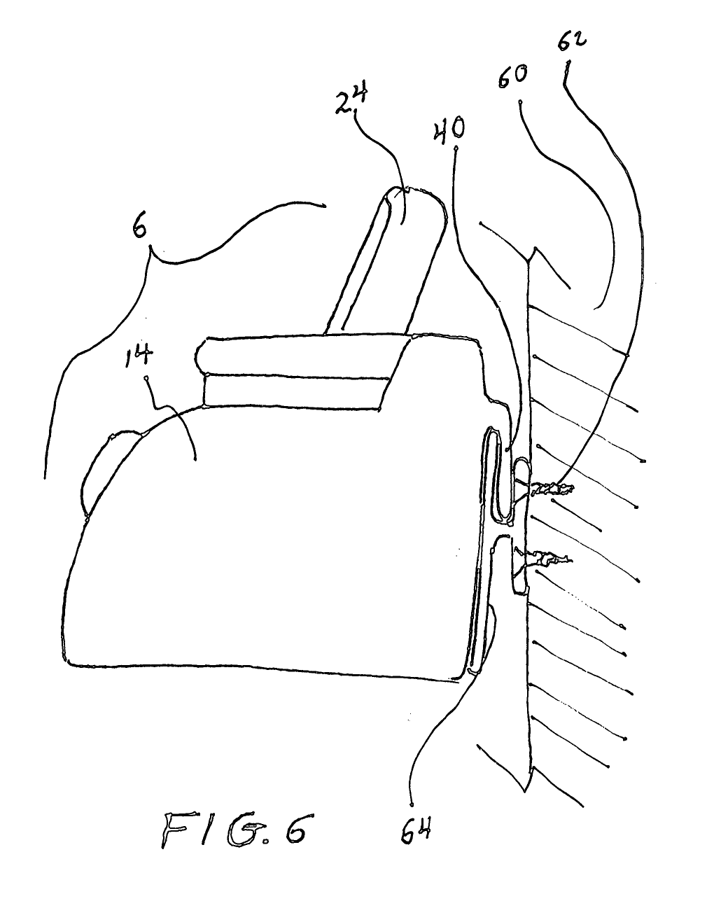

Referring now to FIG. 1 we see a perspective view of the multiple cell phone charging stand of the present invention. The stand consists of a plurality of housings 6, 8, 10, 12 that are attached to each other to form a line. Each housing has a cell phone receiving receptacle 22. a right side wall 14 and a left side wall 2 provide finishing plates that form the sides of the entire charging stand. A family can choose how many charging housings to plug together depending on the total number phones that the family owns. Each cell phone 24 can be removably attached to an adaptor plug 26 which is in turn attached to a universal plug 28. Plug 26 is picked by the user to fit his or her particular cell phone. In this way, the present cell phone stand can be used to charge a variety of different brands of cell phones even if they have different plug configurations. Universal plug 28 is permanently attached to an electrical cord 30 that in turn connects to outgoing cord 16 which terminates in a standard AC to DC charging wall pack transformer, not shown. Name plate pockets 20 allow a person to customize his or her phone charging module with his or her name 21. A rubber trim piece 4 wraps around the lip of each cell phone aperture to protect the phone from being scratched. FIG. 2 shows a side section view of a typical module 12. A standard cell phone 24 rests in receptacle 22. Electrical cord 30 attaches at one end to universal plug 28 and attached adaptor plug 26 which in turn is plugged into a mating jack at the bottom of the cell phone 24. The opposite end of electrical cord 30 terminates in a junction box 48 that connects the cord 30 with secondary cord 36. Cord 36 terminates in a jack 34 located on one side of the housing 12. An elastic band 38 is wrapped around pulleys 44 and 46 and attached to the junction box end of electrical cord 30 to act as a spring bias for electrical cord 30, so that when a person pulls up on phone 24, the attached cord 30 can follow as shown in FIG. 3. When the user detaches phone 24 from plug 26, the plug 26 automatically retracts down to the bottom of receptacle 22. Similarly, when the user wishes to charge phone 24, he or she reaches into receptacle 22, pulls up on adaptor 26 and plugs it into the bottom of the phone. The user then releases the phone gently into receptacle 22 so that it rests as shown in FIG. 2. In this way, a person can charge his or her phone without having to deal with unsightly cables and cords. FIG. 2 also shows charging indicator LED 19 that can be seen through aperture 18. The indicator light 19 derives power via electrical conductors 32 that attached to power socket 34. FIG. 4 shows how two modules 8, 10 plug together. A plug 35 and attached electrical cord 37 on the right side of module 8 connect with a mating socket 34 on the right side of module 10. An indented shoulder 84 on the right side of module 8 plugs into recess 82 on the left side of module 10 thereby physically joining the two modules together. The other modules 6, 12 are similarly joined. In this way, a family can decide how many modules to joint together for their particular needs. FIG. 5 shows a front view of the invention. FIG. 6 shows a side view of the invention where bracket 40 located on the rear of each module 6 can engage a mating wall bracket 64 that is screwed into a wall 60 by standard screws 62. In this way the present invention can be placed either on a flat surface such as a counter top or can be attached to a wall.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Cell phone charging stand comprising:
a plurality of modular hollow housings, each including an upwardly facing cell phone receiving receptacle;
said modular housings capable of attaching to each other to form a line of housings;
a pair of opposing end panels that enclose the far left and far right side of said line of said modular housings;
a name plate retaining pocket located on the front surface of each said modular housing;
said modular housing enclosing a spring biased electrical cord;
said electrical cord connecting on one end to a socket located on the side wall of said housing and on the opposite end to a universal electrical jack;
said universal jack capable of receiving an adaptor plug that can customize said cell phone receiving housing to a user's cell phone;
said side wall socket capable of receiving a mating plug from an adjacent cell phone housing; and
an electrical cord leading to an AC to DC wall pack transformer and standard cell phone charging circuit that supplies electrical power to each said cell phone charging electrical cord.

2. Cell phone charging stand as claimed in claim 1 further comprising a charging indicator light located below each said name plate retaining pocket.

3. Cell phone charging stand as claimed in claim 1 wherein said the rear surface of said housing includes a bracket that can engaged a mating bracket that is attached to a wall so that said charging stand can be mounted to a wall.

4. Cell phone charging stand as claimed in claim 1 wherein the lip of said cell phone receiving receptacle is coated in resilient rubber.
